(19) United States
(12) Patent Application Publication
(10) Pub. No.: US 2011/0114416 A1
(43) Pub. Date: May 19, 2011

(54) Portable modular ladder system

(76) Inventor: David Mayhew, Calgary (CA)

(21) Appl. No.: 12/587,982

(22) Filed: Oct. 15, 2009

(51) Int. Cl. E06C 7/00; E06C 1/04

(52) U.S. Cl. 182/107; 182/194

(57) ABSTRACT

A portable modular ladder system which comprises a plurality of stiles. A plurality of steps are spaced apart which extend laterally from opposite sides of each stile in an alternating manner. A plurality of stabilizers are spaced apart which extend rearwardly from each stile. A mechanism is for interconnecting the plurality of stiles together end to end. .A mechanism is for retaining the plurality of stabilizers against a substantially vertical structure, wherein a person can climb up the plurality of steps on the plurality of stiles.

### BACKGROUND OF THE INVENTION

1. Field of the Invention

The present invention relates to a ladder, and more particularly, a portable modular ladder system.

2. Description of the Prior Art

Numerous innovations for ladder systems have been provided in the prior art that will be described. Even though these innovations may be suitable for the specific individual purposes to which they address, however, they differ from the present invention.

A FIRST EXAMPLE, U.S. Pat. No. 2,744,674, Issued on May 8, 1956, to Smith teaches a sectional ladder comprising a plurality of vertically superposed tubular standards, coupling means joining the standards, the adjacent ends of the standards having notches therethrough opening into the adjacent ends, a cylindrical fitting received in the adjacent ends, the fitting having lugs extending outwardly therefrom received in the notches, a clamp positioned over the adjacent ends and extending therebetween, vertically spaced apertures through the standards, pairs of step sections having an internally threaded end, the other of each of the pairs of step sections having an externally threaded end threadedly engages in the internally threaded end within the tubular standards, inner collars on the step sections, there collars abutting the standard to lock the step sections to the standard, and outer collars on the outer end of the step sections spaced from the inner collars, the step sections being knurled.

A SECOND EXAMPLE, U.S. Pat. No. 3,995,714, Issued on Dec. 7, 1976, to Brookes et al. teaches a portable, light-weight, multi-section step ladder for scaling poles and formed by a main or top section followed by a train of extension sections. Each section includes a single vertical spar and a series of steps secured thereto. The upper end of. the main section is provided with an open-loop assembly adapted to engage the pole and to harness this section to the pole when a downward force is exerted thereon, the lower end of the main section terminating in a coupling head. Each extension section is provided at its upper end with a latching piece adapted to engage a coupling head and at its lower end with a coupling head, whereby the main section and the extension sections may readily be interlinked to form a ladder whose length is sufficient to scale the pole.

A THIRD EXAMPLE, U.S. Pat. No. 4,263,983, Issued on Apr. 28, 1981, to Norton teaches a portable, multisectional ladder for scaling poles, trees and like objects and a method of use thereof. Individual ladder sections are formed of steps welded to individual angle metal sections. The angle metal sections are removably joined using male/female connectors at either end thereof. One or more brackets welded to each section slidably retains an auto-type safety belt which can be releasably buckled about the object to be scaled. The brackets on each section except for the base section include a special belt cincher arrangement which includes means for drawing the belt into the recessed portion of the angle metal to forcibly tighten the belt about the object to be climbed, thereby eliminating any slippage or wobble in the ladder.

A FOURTH EXAMPLE, U.S. Pat. No. 4,411,335, Issued on Oct. 25, 1983, to Forrester teaches a hunting stand and access ladder for use by a hunter to support himself at an elevated position in a tree. The hunting stand includes a frame with a seat and foot support on it, an upper support means on the frame comprising a pair of prongs and a securing member eccentrically arranged so that the prongs are forced into the tree trunk as the frame is moved from an initial tilted position to a final position lying adjacent the tree trunk, and a lower securing means on the frame for holding the stand in the final position. The access ladder is sectional with each section including a central support tube, a cross member at the upper end of the support tube, a pair of support prongs on the cross tube, securing means to force the support prongs into the tree trunk to support the ladder section spaced from the tree trunk, and rungs on the support tube so that the hunter can climb the ladder section.

A FIFTH EXAMPLE, U.S. Pat. No. 5,040,635, Issued on Aug. 20, 1991, to Strickland teaches a tree pole ladder which includes first and second detachable sections. Each of the detachable sections pivotally supports laterally extending steps which are foldable from a horizontally extending position for climbing, to a storage position aligned with the pole section. The detachable sections are coupled together by a coupling section which permits the sections to be rapidly connected and detached to a pair of single pole sections which may be easily transported to remote locations.

A SIXTH EXAMPLE, U.S. Pat. No. 5,253,732, Issued on Oct. 19, 1993, to Daniels teaches a pole ladder folding deer stand that is formed by upper and lower tubular sections hingedly joined in aligned relation and provided with vertically staggered steps for ascending and descending the pole ladder. A seat and backrest assembly hingedly connected with the upper limit of the upper pole section projects horizontally toward a tree and includes a yoke and strap assembly for joining the seat assembly to a tree. A foot platform is horizontally supported above the uppermost step forwardly of the position of the seat assembly. A ladder stabilizing engaging yoke projects laterally from the respective sides of the ladder lower section at its depending end. A bicycle fork journals a wheel attachable to one of the ladder sections to permit wheelbarrow-like movement of the folded ladder tree stand for transporting equipment or game.

A SEVENTH EXAMPLE, U.S. Pat. No. 5,277,273, Issued on Jan. 11, 1994, to Grimes teaches a readily portable device for enabling a vertical columnar structure such as a tree, pole or the like to be climbed without causing damage thereto, this device comprising a pair of rigid, elongate longitudinal members of substantially equal length. These longitudinal members are disposed in a spaced-apart, substantially parallel relationship, with least two step-like members disposed between the longitudinal members, to provide footing to a climber of the vertical structure. A flexible member such as a rope is utilized for tightly encircling the vertical structure, with the flexible member being able to be affixed adjacent the upper end of the device, to form a support therefor. The flexible member is placed insubstantial tension at such time as the vertical structure has been encircled and weight is placed on one of the step-like members. The upper end of the device has a structure-contacting portion, with latter portion being brought into a firm, no-slip relationship with the vertical structure at the time of the tensioning of the flexible member, as a consequence of weight being placed upon one of the step-like members.

AN EIGHTH EXAMPLE, U.S. Pat. No. 5,439,072, Issued on Aug. 8, 1995, to Jenkins Jr. teaches a modular ladder system for climbing tree, comprising at least two ladder modules, each ladder module comprising a hollow, primary support member having an upper end and a lower end; a secondary support member, telescopingly slidable within the primary support member, having an upper end and a lower end; a first step attached to the lower end of the secondary support member; a second step attached to the lower end of the primary support member; a top step attached to the upper end of the primary support member; a spring-loaded lock operatively disposed between the primary support member and the secondary support member for locking the position of the secondary support member relative to the primary support member; at least two stabilizer brackets attached to the primary support member and the secondary support member for stabilizing the ladder module against the tree; and a strap and quick-release buckle attached to the primary support member for holding the ladder module to the tree.

A NINTH EXAMPLE, U.S. Pat. No. 5,806,626, Issued on Sep. 15, 1988, to Jenkins Jr. teaches a portable safety ladder for climbing trees, comprising a single primary, support member having first step; a single secondary support member having a second step, wherein the secondary support member is slidable relative to the primary support member; a locking mechanism operatively disposed between the primary support member and the secondary support member for selectively locking the position of the secondary support member relative to the primary support member; a single flexible strap on the primary support member for suspending the ladder module from the tree, wherein the flexible strap is placed in tension when weight is exerted on the ladder module; first and second stabilizers attached to the primary support member and the secondary support member, respectively, for stabilizing the ladder module against the tree, wherein the first and second stabilizers include surfaces which are caused to forcibly contact the tree when the flexible strap is placed in tension; and a safety loop connected to the flexible strap for allowing a secure attachment between the flexible strap and a coupling device on a climber, wherein the safety loop is constructed in a manner to support the weight of the climber.

A TENTH EXAMPLE, U.S. Pat. No. 5,816,362, Issued on Oct. 6, 1998, to Jenkins Jr. teaches a modular safety ladder system for climbing trees, comprising a single support member having a lower end and an upper end; a bottom step attached to the lower end; a top step attached to the upper end; an intermediate step attached to the support member between the bottom step and the top step; a flexible strap attached to the support member for suspending the ladder module from the tree, wherein the strap is placed in tension when weight is exerted on the ladder module; first and second stabilizers attached to the upper end and the lower end of the support member, respectively, for stabilizing the ladder module against the tree, wherein the first and second stabilizers include surfaces which are caused to forcibly contact the tree when the strap is placed in tension; and a safety loop connected to the strap for allowing a secure attachment between the strap and a coupling device on the climber, wherein the safety loop is constructed in a manner to support the weight of the climber. Optionally, the first and second stabilizers are attached to the top and bottom steps, respectively, wherein each step is removably and lockingly slidable relative to the support member.

AN ELEVENTH EXAMPLE, U.S. Pat. No. 5,860,490, Issued on Jan. 19, 1999, to Petti et al. teaches an ascending and descending device, or ladder, having a single central mast and a hand and two foot supports axially slidably engaging the mast. Each hand and foot support has a spring biased clutch normally preventing axial motion of its associated support along the mast, and a lever for releasing the hand or foot support to move along the mast. The hand support has weight bearing platforms, or grips, projecting to both sides of the mast. Each foot support projects to one side. of the mast. The foot supports are tethered together to limit the distance by which they become separated when lowering one foot support. The mast has at its bottom end a base having folding legs. The mast selectively receives at its top end a pronged support for engaging the roof of a building and a chair to enable a person to remain seated above the ground. The chair has a safety tie for securing the chair to a tree.

A TWELFTH EXAMPLE, U.S. Pat. No. 7,163,082, Issued on Jan. 16, 2007, to Bigard teaches a climbing stick apparatus that includes a plurality of stick members, each of which includes a fastener reception portion at each stick member end and a plurality of foot-support-reception channels. A plurality of member-to-member couplers and fasteners are provided for erecting a plurality of stick members in a longitudinal arrangement. A plurality of foot support members are received in the foot-support-reception channels. The climbing stick apparatus of the invention permits rapid assembly of a climbing stick next to a tree for hunters and other outdoors men. When erected next to a tree the climbing stick apparatus permits the hunter to remain above ground level so that he is not noticed or smelled by game on the floor.

It is apparent now that numerous innovations for ladder systems have been provided in the prior art that adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a portable modular ladder system that avoids the disadvantages of the prior art.

ANOTHER OBJECT of the present invention is to provide a portable modular ladder system that is simple and inexpensive to manufacture.

STILL ANOTHER OBJECT of the present invention is to provide a portable modular ladder system that is simple to use.

BRIEFLY STATED, STILL YET ANOTHER OBJECT of the present invention is to provide a portable modular ladder system which comprises a plurality of stiles. A plurality of steps are spaced apart which extend laterally from opposite sides of each stile in an alternating manner. A plurality of stabilizers are spaced apart which extend rearwardly from each stile. A mechanism is for interconnecting the plurality of stiles together end to end. A mechanism is for retaining the plurality of stabilizers against a substantially vertical structure, wherein a person can climb up the plurality of steps on the plurality of stiles.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic front perspective view of an embodiment of the present invention secured to a tree trunk and used in a typical environment;

FIG. 2 is an enlarged diagrammatic front elevational view of the area shown by arrow 2 in FIG. 1;

FIG. 3 is an enlarged diagrammatic exploded front perspective view of two stiles of the present invention;

FIG. 4 is a further enlarged diagrammatic exploded rear perspective view of the area enclosed in the dotted oval indicated by arrow 4 in FIG. 3, showing a slip joint in greater detail;

FIG. 5 is an enlarged diagrammatic cross sectional view taken along 5-5 in FIG. 2 of the slip joint in greater detail;

FIG. 6 is an enlarged diagrammatic cross sectional view with parts broken away taken along line 6-6 in FIG. 2 showing a stabilizer in greater detail; and

FIG. 7 is an enlarged diagrammatic cross sectional view with parts broken away taken along line 7-7 in FIG. 2.

### A MARSHALING OF REFERENCE NUMERALS UTILIZED IN THE DRAWING

10 portable modular ladder system
12 stile of portable modular ladder system 10
14 step of portable modular ladder system 10
15 top section of stile of portable modular ladder system 10
16 stabilizer of portable modular ladder system 10
18 interconnecting mechanism of portable modular ladder system 10
20 retaining mechanism of portable modular ladder system 10
22 substantially vertical structure
24 person
26 elongate angle member for stile 12
28 leg of elongate angle member 26
30 L-shaped member for step 14
32 tread on L-shaped member 30
34 generally V-shaped retention anchor for stabilizer 16
36 serrated edge on generally V-shaped retention anchor 34
38 slip joint of interconnecting mechanism 18
40 short angle member of slip joint 38
42 aperture in leg 28
44 Y-shaped ratchet strap of retaining mechanism 20
46 clip of retaining mechanism 20
48 stand housing for person 24

### DETAILED DESCRIPTION OF THE PREFERRED EMBODIMENT

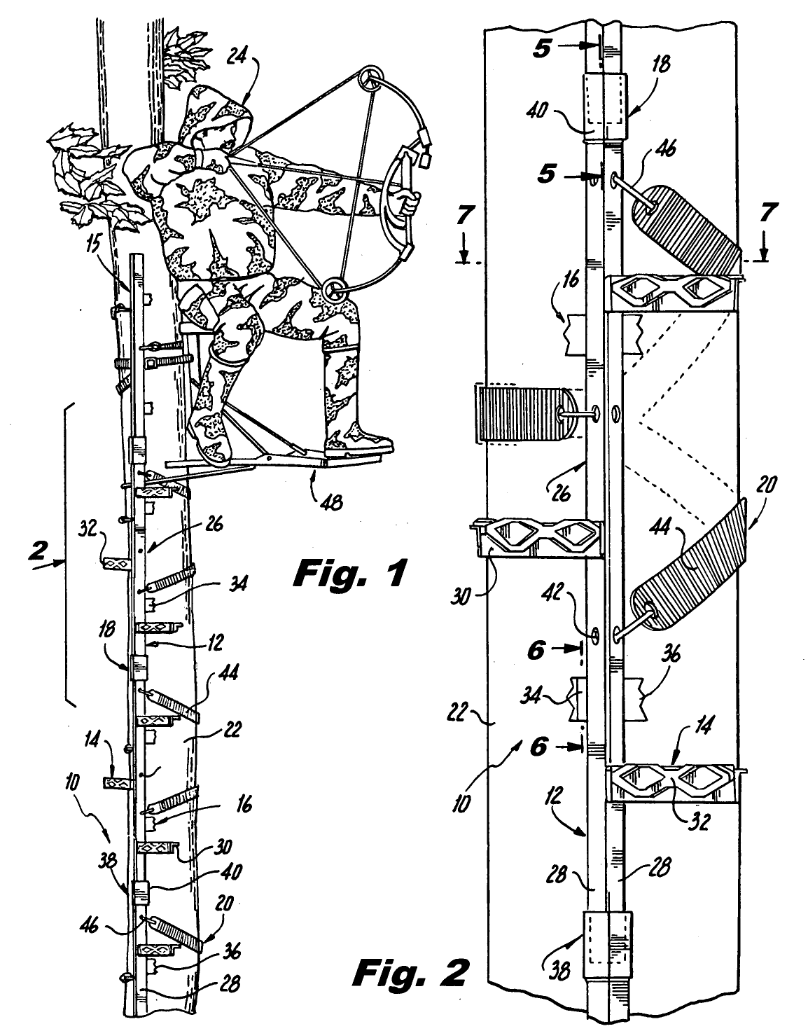

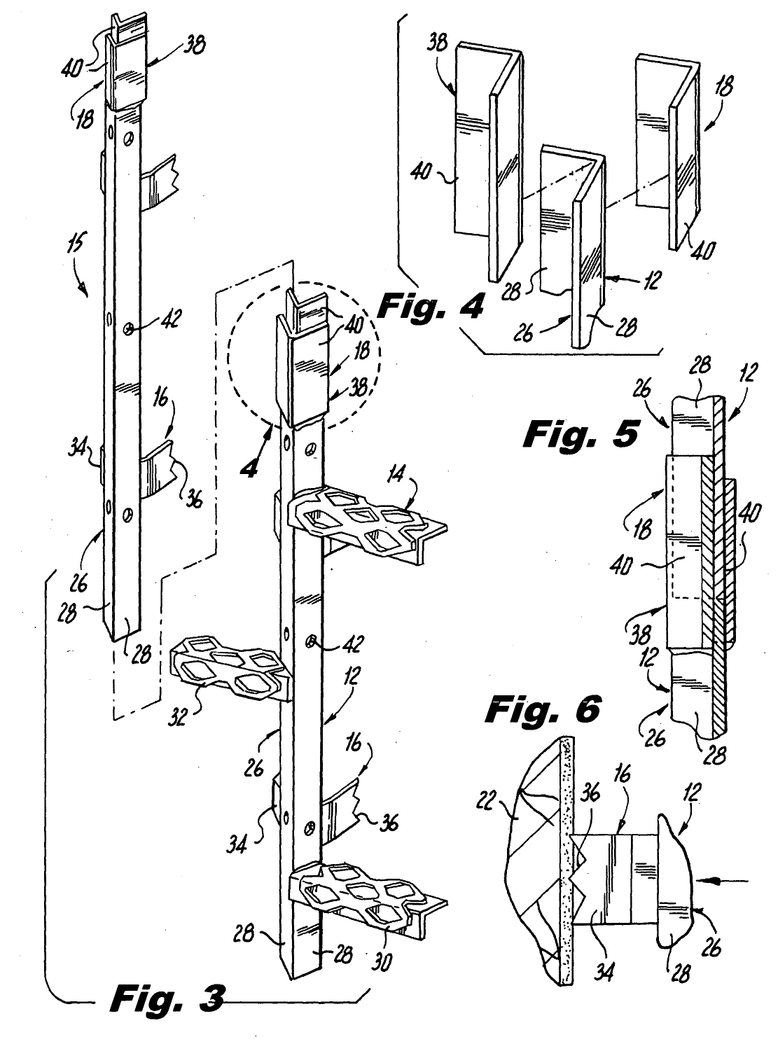

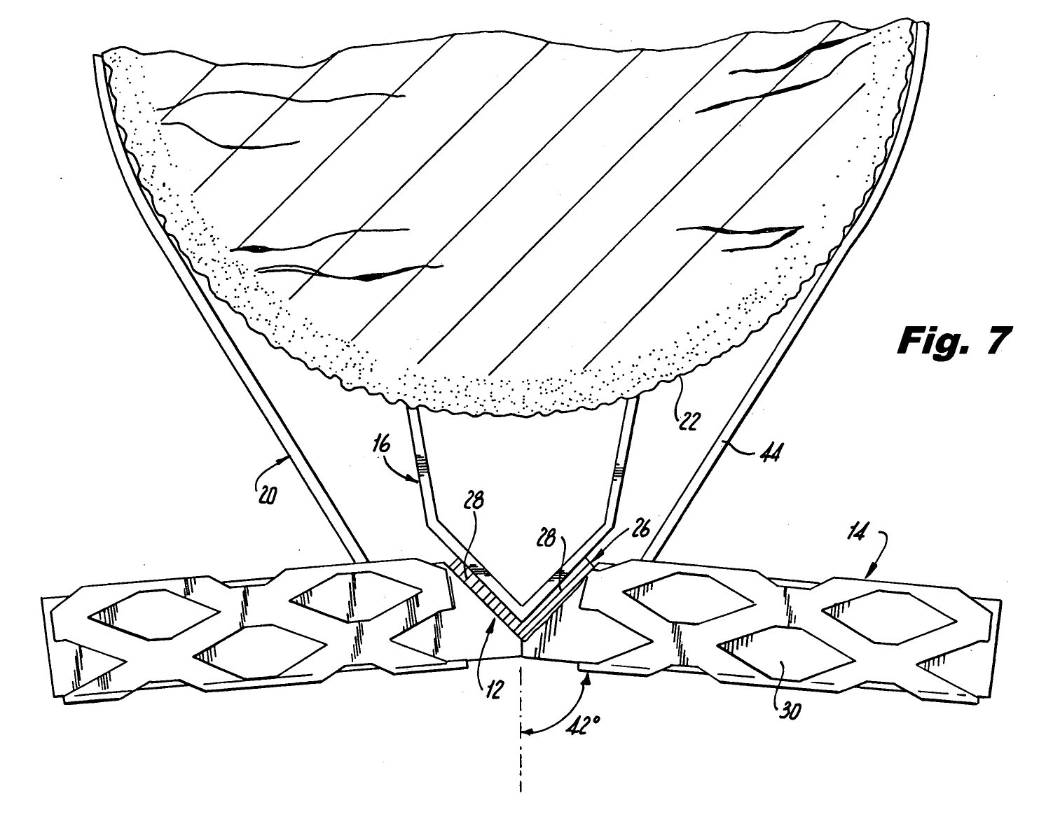

Referring now to the figures, in which like numerals indicate like parts, and particularly to FIGS. 1 through 7, which are a diagrammatic front perspective view of an embodiment of the present invention secured to a tree trunk and used in a typical environment; an enlarged diagrammatic front elevational view of the area shown by arrow 2 in FIG. 1; an enlarged diagrammatic exploded front perspective view of two stiles of the present invention; a further enlarged diagrammatic exploded rear perspective view of the area enclosed in the dotted oval indicated by arrow 4 in FIG. 3, showing a slip joint in greater detail; an enlarged diagrammatic cross sectional view taken along 5-5 in FIG. 2 of the slip joint in greater detail; an enlarged diagrammatic cross sectional view with parts broken away taken along line 6-6 in FIG. 2 showing a stabilizer in greater detail; an enlarged diagrammatic cross sectional view with parts broken away taken along line 7-7 in FIG. 2, and as such, will be discussed with reference thereto.

The present invention is a portable modular ladder system 10 which comprises a plurality of stiles 12. A plurality of steps 14 are spaced apart which extend laterally from opposite sides of each stile 12 in an alternating manner. A plurality of stabilizers 16 are spaced apart which extend rearwardly from each stile 12. A mechanism 18 is for interconnecting the plurality of stiles 12 together end to end. A mechanism 20 is for retaining the plurality of stabilizers 16 against a substantially vertical structure 22, such as a tree or a pole, wherein a person 24 can climb up the plurality of steps 14 on the plurality of stiles 12. The top section 15 of stile of portable modular ladder system is the only sections for which the steps 14 are omitted since they would not serve any useful climbing purpose and additionally might further cause injury to a person 24 perched or sitting on a stand housing 48.

Each stile 12 comprises an elongate angle member 26 having equal legs 28. Each step 14 comprises an L-shaped member 30 which extends at approximately forty two degrees from one leg 28 of the elongate angle member 26. Each step 14 further comprises a tread 32 applied onto the L-shaped member 30 to prevent slippage therefrom.

Each stabilizer 16 comprises a generally V-shaped retention anchor 34 having serrated edges 36 which will make contact with the substantially vertical structure 22. The interconnecting mechanism 18 comprises a plurality of slip joints 38. Each slip joint 38 comprises a pair of short angle members 40, each mounted on an opposite side of an upper end of one elongate angle member 26. A lower end of another elongate angle member 26 can fit into and between the short angle members 40.

The retaining mechanism 20 comprises each elongate angle member 26 having a plurality of spaced apart apertures 42 along each leg 28. A plurality of Y-shaped ratchet straps 44 are provided. A plurality of clips 46 are also provided. Each clip 46 extends between an end of one Y-shaped ratchet strap 44 and one aperture 42 in one leg 28 of one elongate angle member 26. Each Y-shaped ratchet strap 44 will tightly wrap about the substantially vertical structure 22.

A stand housing 48, as shown in FIG. 1. may be removably mounted to the uppermost stile 12 and the substantially vertical structure 22. The person 24 being a hunter can now sit upon a stand housing 48 and hunt therefrom.

It will be understood that each of the elements described above, or two or more together, may also find a useful application in other types of constructions differing from the types described above.

While the invention has been illustrated and described as embodiments of a portable modular ladder system, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A portable modular ladder system which comprises:
a) a plurality of stiles;
b) a plurality of steps spaced apart which extend laterally from opposite sides of each said stile in an alternating manner;
c) a plurality of stabilizers spaced apart which extend rearwardly from each said stile;
d) means for interconnecting said plurality of stiles together end to end; and
e) means for retaining said plurality of stabilizers against a substantially vertical structure, wherein a person can climb up said plurality of steps on said plurality of stiles.

2. The system as recited in claim 1, wherein each said stile comprises an elongate angle member having equal legs.

3. The system as recited in claim 2, wherein each said step comprises an L-shaped member which extends at approximately forty two degrees from one said leg of said elongate angle member.

4. The system as recited in claim 3, wherein each said step further comprises a tread applied onto said L-shaped member to prevent slippage therefrom.

5. The system as recited in claim 1, wherein each said stabilizer comprises a generally V-shaped retention anchor having serrated edges which will make contact with the substantially vertical structure.

6. The system as recited in claim 2, wherein said interconnecting means comprises a plurality of slip joints.

7. The system as recited in claim 6, wherein each said slip joint comprises a pair of short angle members, each mounted on an opposite side of an upper end of one said elongate angle member, wherein a lower end of another said elongate angle member can fit into and between said short angle members.

8. The system as recited in claim 2, wherein said retaining means comprises:
a) each said elongate angle member having a plurality of spaced apart apertures along each said leg;
b) a plurality of Y-shaped ratchet straps; and
c) a plurality of clips, in which each said clip extends between an end of one said Y-shaped ratchet strap and one said aperture in one said leg of one said elongate angle member, wherein each said Y-shaped ratchet strap will tightly wrap about the substantially vertical structure.

9. A portable modular ladder system which comprises:
a) a plurality of stiles;
b) a plurality of steps spaced apart which extend laterally from opposite sides of each said stile in an alternating manner;
c) a plurality of stabilizers spaced apart which extend rearwardly from each said stile;
d) means for interconnecting said plurality of stiles together end to end;
e) means for retaining said plurality of stabilizers against a substantially vertical structure, wherein a person can climb up said plurality of steps on said plurality of stiles;
f) wherein each said stile comprises an elongate angle member having equal legs;
g) wherein each said step comprises an L-shaped member which extends at approximately forty two degrees from one said leg of said elongate angle member;
h) wherein each said step further comprises a tread applied onto said L-shaped member to prevent slippage therefrom;
i) wherein each said stabilizer comprises a generally V-shaped retention anchor having serrated edges which will make contact with the substantially vertical structure;
j) wherein said interconnecting means comprises a plurality of slip joints
k) wherein each said slip joint comprises a pair of short angle members, each mounted on an opposite side of an upper end of one said elongate angle member; and
l) wherein a lower end of another said elongate angle member can fit into and between said short angle members wherein said retaining means further comprises:
i) each said elongate angle member having a plurality of spaced apart apertures along each said leg;
ii) a plurality of Y-shaped ratchet straps; and
iii) a plurality of clips, in which each said clip extends between an end of one said Y-shaped ratchet strap and one said aperture in one said leg of one said elongate angle member, wherein each said Y-shaped ratchet strap will tightly wrap about the substantially vertical structure.
